(19) United States
(12) Patent Application Publication
(10) Pub. No.: US 2006/0237175 A1
(43) Pub. Date: Oct. 26, 2006

(54) Heat exchanger for cehicle use

(75) Inventor: Takuya Hara, Kariya-City (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-City (JP)

(21) Appl. No.: 11/473,422

(22) Filed: Jun. 22, 2006

Related U.S. Application Data
(63) Continuation of application No. PCT/JP04/19756, filed on Dec. 25, 2003.

(30) Foreign Application Priority Data
Dec. 25, 2003 (JP) 2003-429003

(51) Int. Cl. B60K 11/04

(52) U.S. Cl. 165/140; 165/67; 180/68.4; 180/68.1

(57) ABSTRACT

A second attaching portion 8, in which a shroud 20 is attached to a radiator 1, is formed at a position shifted from a first attaching portion 17, at which a condenser 10 is attached to the radiator 1, at predetermined intervals in a vehicle width direction. As a result, it is possible to prevent the weights of the condenser 10 and the shroud 20 from concentrating upon a root portion of a specific tube 2 via the first and the second attaching portion 17, 8. Therefore, damage to tube 2 can be suppressed.

### CROSS-REFERENCE TO RELATED APPLICATIONS

This application is based upon and claims the priority of Japanese Patent Application No. 2003-429003, filed Dec. 25, 2003, the contents being incorporated therein by reference, and a continuation of PCT/JP2004/019756.

### TECHNICAL FIELD The present invention relates to a heat exchanger, for vehicle use, in which a condenser and a shroud are incorporated into a radiator.

### BACKGROUND ART

A conventional heat exchanger is disclosed, for example, in the official gazette of JP-A-9-30246. According to the structure disclosed in the above patent document, only a condenser or a shroud is attached to a radiator. In order to simplify the assembling work of assembling a heat exchanger to a vehicle body, investigations have been recently made into a method of assembling the heat exchanger in such a manner that a condenser 10 and shroud 200 are previously attached to a radiator 1 and the thus assembled radiator 1 is mounted in the vehicle body as shown in FIGS. 8 to 10. As is well known, the radiator 1 includes: a plurality of tubes (not shown) arranged in parallel with each other; and tank portions 300, 301 having core plates 300a, 301a into which upper and lower end portions of the plurality of tubes are inserted. Attaching portions 302, 303 are respectively formed on an upstream side wall face and a downstream side wall face of the tank portions 300, 301 in the air flowing direction. To the attaching portions 302 on the upstream side wall faces of the tank portions 300, 301, the condenser 10 is fastened and fixed by a fastening means 101 via brackets 100. To the attaching portion 303 on the downstream side wall faces of the tank portions 300, 301, the attaching portions 201 of the shroud 200 are fastened and fixed by a fastening means 202.

In this connection, when the attaching portion 302 and the attaching portion 303 are arranged close to each other in the vehicle width direction as shown in FIG. 10, the weights of the condenser 10 and the shroud 200 are applied to the attaching portions 302, 303 and are concentrated. Therefore, stress is concentrated upon root portions of the tubes arranged close to the attaching portions 302, 303 of the tubes which are arranged in parallel with each other. In this case, the root portions of the tubes are portions in which the tubes are inserted into the core plates 300a, 301a. Accordingly, there is a possibility that the tubes are damaged.

### DISCLOSURE OF THE INVENTION

The present invention has been accomplished to solve the above problems. An object of the present invention is to ensure a root portion strength of a tube, with respect to a core plate, in a heat exchanger to the radiator of which a condenser and shroud are attached.

In order to accomplish the above object, the following technical means is employed.

According to a first aspect of the present invention, there is provided a heat exchanger, for vehicle use, comprising: a radiator (1) including a plurality of tubes (2) arranged in parallel with each other and in which coolant flows, also including a plurality of fins (3) arranged between the tubes (2), also including an upper tank portion (4) connected to upper end portions of the plurality of tubes (2) and also including a lower tank portion (5) connected to lower end portions of the plurality of tubes (2); a condenser (10) arranged on an upstream side of the radiator (1), in which refrigerant of a refrigerating cycle flows; and a shroud (20) arranged on a downstream side of the radiator (1), to which a blower (21) for blowing cooling air to the condenser (10) and the radiator (1) is assembled, for guiding the flow of air generated by the blower (21) to the radiator (1), wherein the upper tank portion (4) includes a first attaching portion (17) to which the condenser (10) is attached and also includes a second attaching portion (8) to which the shroud (20) is attached, and a position of the first attaching portion (17) and a position of the second attaching portion (8) are shifted from each other in the vehicle width direction at predetermined intervals.

Due to the foregoing, it is possible to prevent the weights of a shroud and condenser from being concentrated upon a root portion of a specific tube. Therefore, it is possible to ensure the root portion strength of the tube.

Incidentally, the reference numerals in parentheses, to denote the above means, are intended to show the relationship of the specific means which will be described later in an embodiment of the invention.

The present invention may be more fully understood from the description of preferred embodiments of the invention set forth below, together with the accompanying drawings.

### BRIEF DESCRIPTION OF THE DRAWINGS

FIG. 1 is a view showing a radiator of an embodiment, wherein this view is taken from the rear of a vehicle.

FIG. 2 is a view showing a state in which a condenser is attached to a radiator, wherein this view is taken from the front of a vehicle.

FIG. 3A is a view showing an upper tank portion, wherein the view is taken in direction A of FIG. 1.

FIG. 3B is a view showing a lower tank portion, wherein the view is taken in direction B of FIG. 1.

FIG. 4 is a view showing a state in which a shroud is attached to a radiator, wherein the view is taken from the rear of a vehicle.

FIG. 5 is a view showing a state in which a condenser and shroud are attached to a radiator, wherein the view is taken from the side of a vehicle.

FIGS. 6A and 6B are views showing a structure in which an upper portion of a shroud is engaged and fixed to a radiator.

FIGS. 7A and 7B are views showing a structure in which a lower portion of a shroud is engaged and fixed to a radiator.

FIG. 8 is a view showing a state in which a condenser is attached to a radiator of the prior art, wherein the view is taken from the front of a vehicle.

FIG. 9 is a view showing a state in which a shroud is attached to a radiator of the prior art, wherein the view is taken from the rear of a vehicle.

FIG. 10A is a view showing an upper tank portion, wherein the view is taken in direction D of FIG. 1.

FIG. 10B is a view showing a lower tank portion, wherein the view is taken in direction E of FIG. 1.

### BEST MODE FOR CARRYING OUT THE INVENTION

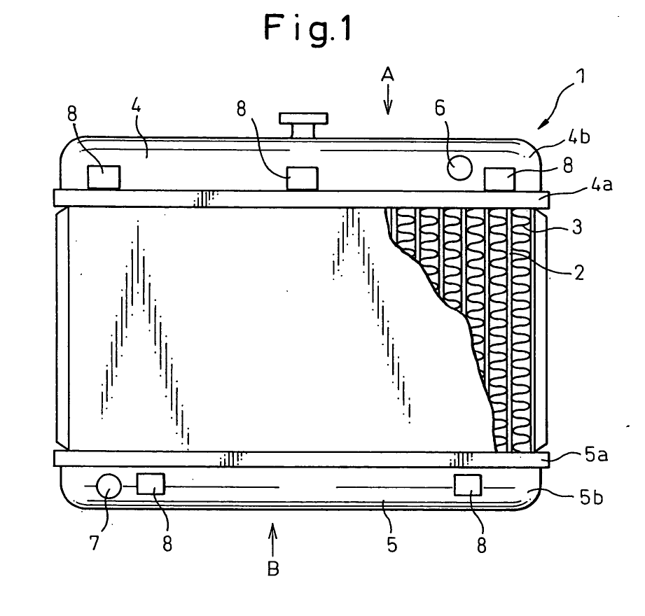

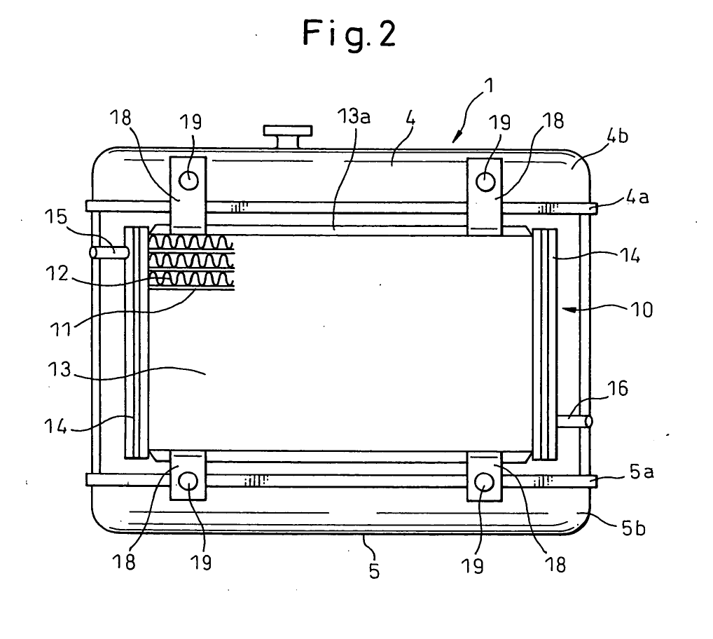

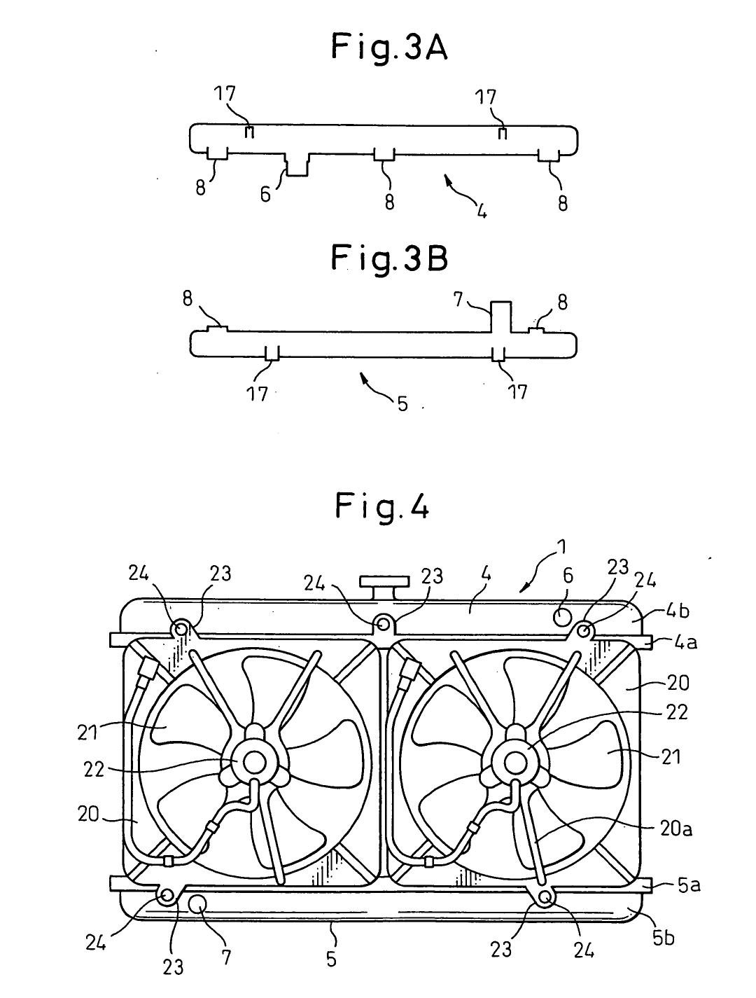

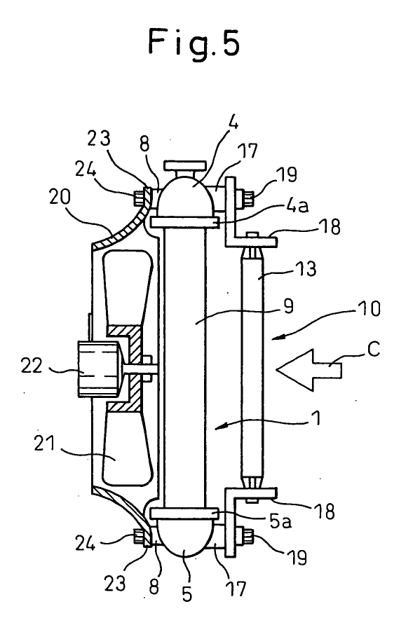

Referring to FIGS. 1 to 5, an embodiment of the present invention will be explained below. In this connection, FIG. 1 is a view showing a radiator 1, wherein the view is taken from the rear of a vehicle, FIG. 2 is a view showing a state in which a condenser 10 is attached to a radiator 1, wherein the view is taken from the front of a vehicle, FIG. 3A is a view showing an upper tank portion 4, wherein the view is taken in direction A of FIG. 1, FIG. 3B is a view showing a lower tank portion 5, wherein the view is taken in direction B of FIG. 1, FIG. 4 is a view showing a state in which a shroud 20 is attached to the radiator 1, wherein the view is taken from the rear of a vehicle, and FIG. 5 is a view showing a state in which the condenser 10 and shroud 20 are attached to the radiator 1, wherein the view is taken from the side.

A heat exchanger of the present invention includes: a radiator 1 for air-cooling the coolant of an engine (not shown) used for running; a condenser 10, which is arranged on an upstream side of an air flow of the radiator 1, for condensing and liquidizing the refrigerant of an air conditioner; and a shroud 20, which is arranged on a downstream side of an air flow of the radiator 1, for guiding a flow of air generated by a fan to the radiator 1 and the condenser 10.

As shown in FIG. 1, the radiator 1 includes: a plurality of tubes 2 arranged in parallel with each other; a plurality of corrugated fins 3, which are arranged between the tubes, for facilitating heat exchange; an upper tank portion 4 to which upper end portions of the tubes 2 are connected; and a lower tank portion to which lower end portions of the tubes 2 are connected. The upper and the lower tank portion 4, 5 include: core plates 4a, 5a onto which the tubes 2 are inserted; and tank bodies 4b, 5b fixed to the core plates 4a, 5a being caulked. In this connection, the tubes 2 and the fins 3 compose a core portion 9 which is a radiating portion.

An inlet pipe 6, into which the coolant flows, is provided in the upper tank portion 4, and an outlet pipe 7, from which the coolant flows out after exchanging heat, is provided in the lower tank portion 5. Second attaching portions 8 described later are formed in the upper and the lower tank 4, 5.

As shown in FIG. 2, the condenser 10 includes: a plurality of tubes 11 which are arranged in parallel with each other; a plurality of corrugated fins 12, which are arranged between the tubes 11, for enhancing the heat exchanging performance; and header tanks 14 connected to both end portions of the tubes 11. The header tank 14 includes: an inlet pipe 15 through which the refrigerant flows into the condenser 10; and an outlet pipe 16 through which the refrigerant flows out from the condenser 10. In this connection, the tubes 11 and the fins 12 compose a core portion 13 which is a radiating portion.

Outside the fin 12 which is arranged at the most outside position, an insert 13a, which is a reinforcing member, is arranged. An L-shaped bracket 18 is attached to the insert 13a by means of brazing. As shown in FIGS. 3A and 3B, on the upstream side wall faces of air flow of the upper and the lower tank portion 4, 5, a first attaching portion 17 is formed. As shown in FIGS. 2 and 5, a bracket 18 is fastened and fixed to the first attaching portion 17 by a fastening means such as a screw.

As shown in FIG. 4, reference numeral 21 is a suction type cooling fan which is arranged on the downstream side (the rear side of a vehicle) of an air flow of the radiator 1. In this case, two sets of cooling fans 21 are arranged in parallel with each other. These cooling fans 21 are composed of well-known axial fans which blow cooling air from the front to the rear of a vehicle (in the direction shown by reference mark C in FIG. 5). These cooling fans 21 are driven and rotated by motors 22. Reference numeral 20 is a shroud for guiding a flow of air sent from the cooling fan 21. Reference numeral 21a is a stay integrally formed with the shroud 21. This stay 21a supports a motor 22.

At positions of the shroud 20 opposing to the second attaching portions 8 of the upper and the lower tank 4, 5, the attaching portions 23 are integrally formed. As shown in FIGS. 3A, 3B, on wall faces of on the downstream side of an air flow of the upper and the lower tank 4, 5, the second attaching portions 8 are formed. As shown in FIGS. 4 and 5, the attaching portions 23 are fastened and fixed by the fastening means 24 such as screws.

As shown in FIGS. 3A and 3B, the first attaching portion 17 and the second attaching portion 8 are formed at positions which are shifted from each other in the vehicle width direction.

The first attaching portion 17 receives the weight of the condenser 10 and the second attaching portion 8 receives the weight of the shroud 20. These weights are applied to root portions of the tubes 2 located in the neighborhood of the attaching portions 17, 18 via the core plates 4a, 5a. In this case, the root portions of the tubes 2 are portions where the tubes 2 are inserted onto the core plates 4a, 5a. In this embodiment, the first attaching portion 17 and the second attaching portion 8 are formed at positions which are shifted from each other in the vehicle width direction. Therefore, the weight of the condenser 10 and the weight of the shroud 20 can be dispersed. Accordingly, it is possible to prevent the occurrence of an excessively high stress concentration upon specific tubes 2. Consequently, it is possible to prevent the root portion of the tube 2 from being damaged.

In this connection, concerning the offset of the first attaching portion 17 and the second attaching portion 8, in the case where the width of the radiator 1 is 730 to 740 mm, it is desirable that the offset is not less than 30 mm.

Finally, another embodiment will be explained below. In this connection, in the embodiment described above, the condenser 10 and the shroud 20 are fastened and fixed to the radiator 1 by the fastening means 19, 24. However, it is possible to adopt a method in which the condenser 10 and the shroud 20 are attached to the radiator 1 being engaged by elastically deformable engagement pawls.

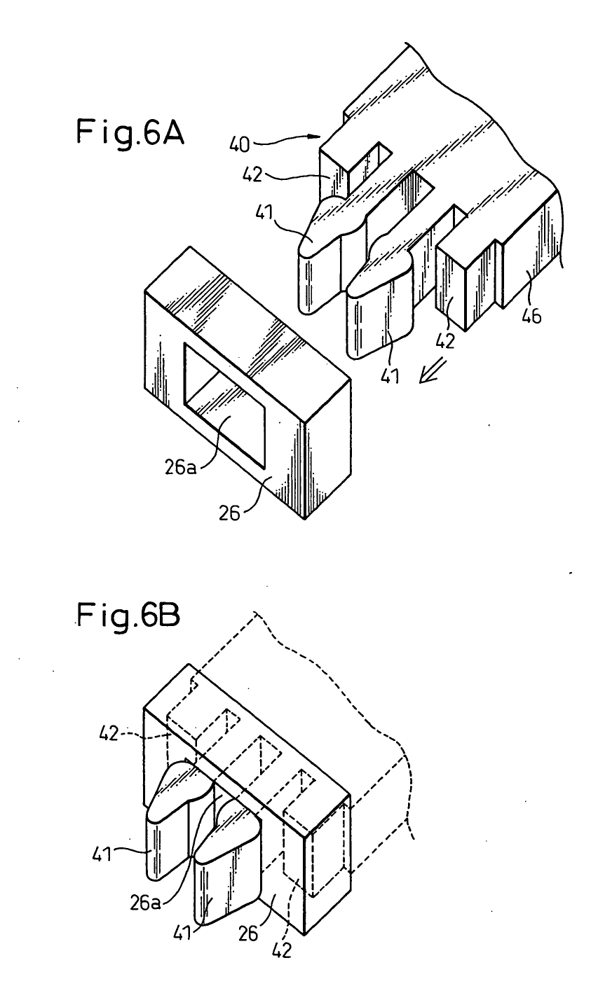

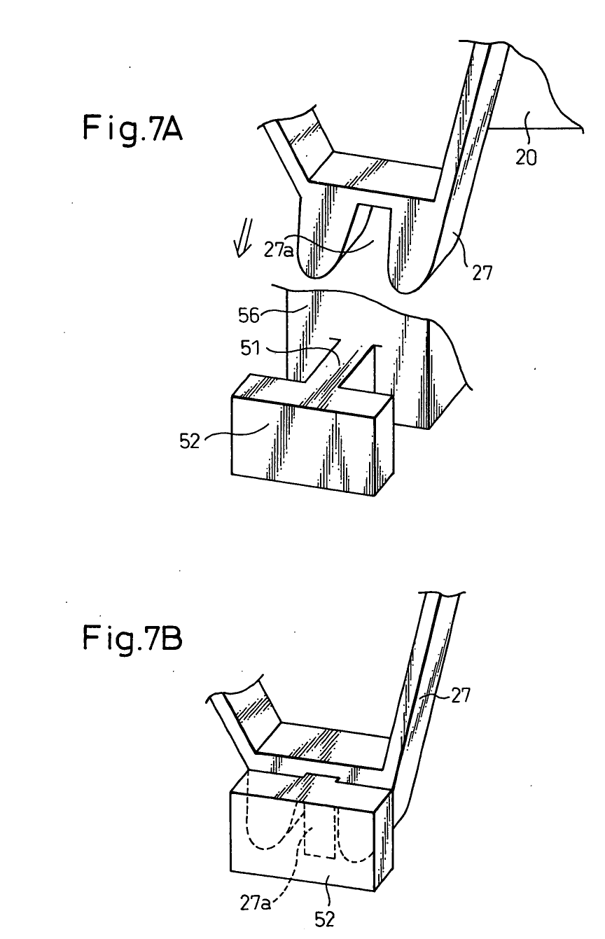

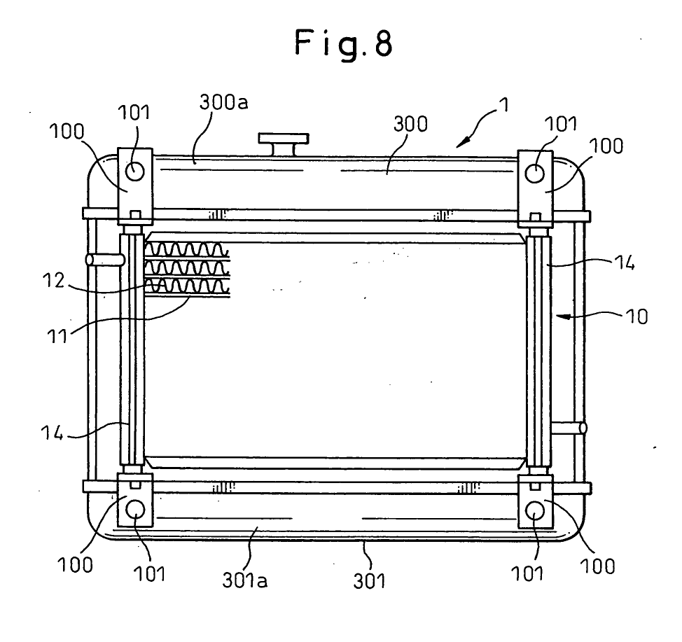

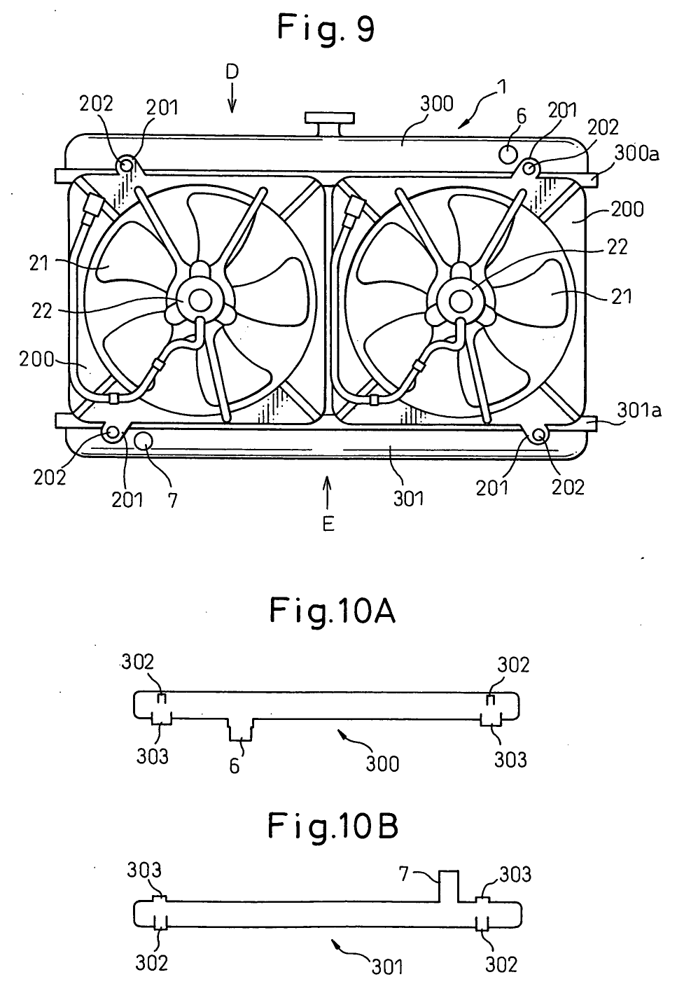

FIGS. 6A and 6B are views showing a structure by which an upper portion of the shroud 20 is engaged and fixed to the radiator 1. FIGS. 7A and 7B are views showing a structure by which a lower portion of the shroud 20 is engaged and fixed to the radiator 1.

As shown in FIG. 6A, in the tank body 4b of the upper tank 4 of the radiator 1, engagement pawls 41 are integrally formed and rectangular protrusions 42 are also integrally formed outside the engagement pawls 41. The engagement pawl 41 and the protruding portion 42 will be generally referred to as an engagement protruding portion 40, hereinafter. On the other hand, in a portion corresponding to the engagement protruding portion 40 of the shroud 20, a protruding portion 26 is formed which protrudes from an outer wall face of the shroud 20 as shown in FIG. 6A. In the protruding portion 26, an opening portion 26a is formed which is capable of engaging with the engagement pawl 41. A forward end portion of the engagement pawl 41 is formed so that it can not come out easily. Therefore, after the engagement pawl 41 has once engaged with the opening portion 26a, as long as the engagement pawl 41 is not deformed, it is difficult for the engagement pawl 41 to come out from the opening portion 26a.

As shown in FIG. 7A, in the tank body 5b of the lower tank 5 of the radiator 1, a protruding portion 51, which protrudes onto the downstream side of an air flow, is formed. At a forward end portion of this protruding portion 51, a rectangular engagement portion 52, which extends in a direction perpendicular to the direction in which the protruding portion 51 protrudes, is formed integrally with the protruding portion 51 and the tank body 51. The protruding portion 51 and the engaging portion 52 will be generally referred to as an engagement protruding portion 50, hereinafter. On the other hand, in a portion corresponding to the engagement protruding portion 50 of the shroud 20, a stay member 27, in which a substantially U-shaped groove portion 27a is formed, is integrally formed as shown in FIG. 7A.

When the shroud 20 is fixed to the radiator, the operation is conducted as follows. First, as shown in FIG. 7B, when the groove portion 27a of the stay member 27 is inserted into the protruding portion 51, the lower portion of the shroud 20 is engaged and fixed. At this time, it is possible to prevent the groove portion 27a from being disengaged from the protruding portion 51 by the engaging portion 52. Successively, the engagement pawl 41 is elastically deformed and engaged with the opening portion 26a. At this time, the protruding portion 42 comes into contact with an inner wall face of the protruding portion 26. Therefore, a perpendicular weight of the shroud 20, which supports the weights of the cooling fan 21 and the motor 22, can be supported.

As described above, the method of attaching the condenser 10 and the shroud 20 is not necessarily limited to the fastening method. The attaching method conducted in the upper tank 4 and the attaching method conducted in the lower tank 5 may be different from each other.

In the above embodiment, the position of the first attaching portion 17 and the position of the second attaching portion 8 are shifted from each other in both the upper tank 4 and the lower tank 5. However, it is possible to adopt an embodiment in which the position of the first attaching portion 17 and the position of the second attaching portion 8 are shifted from each other only in the upper tank 4.

While the invention has been described by reference to specific embodiments chosen for purposes of illustration, it should be apparent that numerous modifications could be made thereto by those skilled in the art without departing from the basic concept and scope of the invention.

1. A heat exchanger for vehicle use comprising:
a radiator including a plurality of tubes arranged in parallel with each other and in which coolant flows, also including a plurality of fins arranged between the tubes, also including an upper tank portion connected to upper end portions of the plurality of tubes and also including a lower tank portion connected to lower end portions of the plurality of tubes;
a condenser arranged on an upstream side of the radiator, in which refrigerant of a refrigerating cycle flows; and
a shroud arranged on a downstream side of the radiator, to which a blower for blowing cooling air to the condenser and the radiator is assembled, for guiding the flow of air generated by the blower to the radiator, wherein
the upper tank portion includes a first attaching portion to which the condenser is attached and also includes a second attaching portion to which the shroud is attached, and a position of the first attaching portion and a position of the second attaching portion are shifted from each other in the vehicle width direction at predetermined intervals.

2. A heat exchanger according to claim 1, wherein the first attaching portion and the second attaching portion are alternately provided in the vehicle width direction.

3. A heat exchanger according to claim 1, wherein the first attaching portion and the second attaching portion are provided in the lower tank portion.

4. A heat exchanger according to claim 2, wherein the first attaching portion and the second attaching portion are provided in the lower tank portion.
